(19) United States
(12) Patent Application Publication
(10) Pub. No.: US 2010/0309159 A1
(43) Pub. Date: Dec. 9, 2010

(54) RESTROOM MIRROR

(75) Inventor: Oliver Roettcher, Gottmadingen-Randegg (DE)

Correspondence Address: LUCAS & MERCANTI, LLP, 475 PARK AVENUE SOUTH, 15TH FLOOR, NEW YORK, NY, 10016, US

(73) Assignee: MIRROR IMAGE AG, STEINACH (CH)

(21) Appl. No.: 12/864,948

(22) PCT Filed: Jan. 28, 2009
(86) PCT No.: PCT/EP09/00530

§ 371 Date: Aug. 5, 2010

(30) Foreign Application Priority Data
Jan. 28, 2008 (DE) 20 2008 001 253.8

(51) Int. Cl. G06F 3/041; G02B 7/182; F21V 33/00; G06F 3/02

(52) U.S. Cl. 345/173; 359/872; 362/144; 345/156

(57) ABSTRACT

The invention relates to a restroom mirror with a housing comprising a mirror area (20, 32) providing a concave mirror optical effect at a second flat side opposite a first flat side, wherein fastening and adjusting means (10, 12) are disposed at the housing such that the housing can be fixed at a horizontal or vertical surface and can be rotated, swiveled and/or tilted through manual and/or mechanical actuation, wherein a flat screen is provided (16) at the first flat side inside the housing, said screen being designed for the display of electronic image signals, wherein the housing, which is designed to be sealed for spray water and/or water vapor resistance and/or for compatibility with humid areas, can be moved from a first observation position of the flat screen to a second observation position of the mirror area through said actuation and the fastening means comprise a hinge (12); for facilitating the rotating, swiveling or tilting, said hinge as the central connection having cabling running therethrough for the electrical system provided in the housing.

The present invention relates to a restroom mirror according to the preamble of the main claim. Restroom mirrors of this kind, such as provided in the form of make-up and/or shaving mirrors with correspondingly concave magnifying effect are generally known from the state of the art and are part of the standard equipment of restrooms such as bathrooms in hotels, and can also be frequently found in the private sanitary field.

Further, another item known from the state of the art, is a visual display unit having a commonly used flat screen such as in the form of a TFT screen unit, which in the form of housings fixedly attached to a wall, for example, and equipped with a flat TV screen, permits digital viewing of visual media, wherein an operator, in order to achieving a favourable viewing position, may perform a simple adjustment of the housing through manual actuation.

The increasing distribution of electronic media and associated display units, in particular of flat screens for displaying various audio-visual media, has resulted in the need for correspondingly flexible universal fields of application for such media-display units. Especially in the field of hotels and restaurants, this applies to bathrooms and wet rooms, which up to now have, only infrequently or not at all, been equipped with playback or visual display units for audio-visual electronic media (and which present corresponding fitting problems due to not unproblematic environmental conditions, in particular humidity). Accordingly therefore, it is known albeit from the state of the art to equip bathrooms or similar wet rooms with screens for displaying audio-visual media which are fixedly installed in cupboards or the like, but this means that, apart from the corresponding expense during installation, planning in advance is required and it is all but easy, in particular, to retrofit already existing objects.

It is therefore the requirement of the invention to make a digital display unit accessible, even given potentially problematic environmental conditions, as they commonly occur in the presence of humidity or water vapours in restrooms, for example, and to develop units moreover, which are suitable for retrofitting, in a simple way and with little expense, in already fully fitted, existing living, hotel or sanitary environments.

This requirement is met by the restroom mirror utilised additionally as a visual display unit and having the features of the main claim; advantageous further developments of the invention are described in the sub-claims.

For within the framework of the invention it has been found, initially, to be advantageous and synergistic that a generic restroom mirror which frequently is also equipped with electric lighting, is ideally suited for additionally receiving a flat screen in its housing, wherein this arrangement is adapted both conceptually and constructively to ideally suit the problematic conditions, in particular humidity, which prevail in restrooms.

In an inventive and advantageous manner the housing already used for receiving the concave mirror is thus used for a further synergistic purpose, i.e. by providing a flat screen on its further (first) flat side. According to the invention the fastening and adjusting means are designed in such a way that by using them, the housing, through simple manual actuation, can be moved from a first viewing position of the flat screen (i.e. for viewing an audio-visual medium for example) into the second viewing position (for use of the concave mirror by an operator); in this way it is possible in a simple and elegant manner, not only to extend the field of application of mirror housings, but a synergistic effect also results on several levels: for example, the typically already existing supply line for the energy and signal supply on an otherwise known television set can be used to additionally illuminate the mirror, also from the back so that in this respect no further cabling is necessary. Furthermore a mirror frequently already present in sanitary areas can be distinctly enhanced in its functionality by providing the possibility of an image display without any further separate installations being required, thus also drastically simplifying any retrofit of existing rooms (for example bathrooms). Finally using the example of a bathroom as an application scenario—it could be imagined that an operator, while performing the morning wash and using one and the same unit, watches the news, then, by means of the concave mirror, performs a shave or a make-up operation and possibly even, in this operating state (of the second viewing position according to the invention) watches the TV image on the screen through a further stationary rearward mirror.

For the above described reasons the installation expense for outfitters and operators of hotels or similar facilities is thus kept within distinct limits, and added value for users is definitely to be expected.

According to further developments it is advantageous, on the one hand, to implement the whole of the inwardly arched concave mirror area as the second flat side of the housing (for example by means of a wholly or partly metallised mirror insert), alternatively or according to a further preferred embodiment, it is feasible to implement the concave mirror area on merely a part of the surface of or on the second flat side and to implement a plane mirror area or the like which preferably surrounds the concave mirror area.

Moreover it is especially favourable to provide the second flat side and/or the first flat side (external to the flat screen) with light sources as light fittings either by embedding such light sources into respective surfaces or by back-lighting respective (partially) light-translucent surfaces or surface areas. For the second flat side, i.e. the arrangement of the concave mirror, illumination of the respectively viewed body surface can thus be achieved in an exceedingly favourable manner, which, for example simplifies shaving (wherein the additional positive effect is being utilised in that, possibly for the energy supply to such a light source, the already existing supply line for the flat screen can be used, without necessitating new additional cabling). With regard to the first flat side such additional light, possibly suitably dimmed and/or set to a colour, may be used for creating special ambient effects, for example for decorative or therapeutic purposes.

With this arrangement it is preferred, to either design the light source (preferably separately) so as to be switchable, whereby this can be done using conventional switches, a switching surface area on the first and/or the second flat side, or also using a remote control (such as a wireless control), or additionally or alternatively it is favourable to effect activation of such a light source via program-control, wherein, possibly taking into account environmental lighting, the time of day, the current switch-on state of the flat screen or other parameters, suitable illumination can be automatically selected and activated via program control.

According to a preferred embodiment it is also favourable to design the flat screen (at least a partial surface thereof) as a touch-sensitive screen (touch-screen); this, on the one hand, leads to the advantage that separate adjusting or operating elements are not necessary, but rather that suitable parameters, such as sound level, program selection, switching-on/off etc. may be achieved by simply touching correspondingly provided switching or adjusting surfaces in an otherwise known manner on the screen surface. The additional advantage lies in the fact that such an operation renders expensive sealing of operating elements (such as buttons, controllers or the like) which would otherwise be necessary, superfluous, which, in particular, has a positive and simplifying effect in humidity-laden or water-vapour-laden environments such as bathrooms.

Supply of the signal to the flat screen (or an associated video signal reception unit) may be effected either wirelessly in an otherwise known manner, for example using a television tuner, a Bluetooth, WLAN or any other preferably standardised radio or infrared connection to an external video signal source. Alternatively a wired connection may be provided for this video signal source, wherein, according to a preferred further development, a common cable connection with the necessary electrical mains supply can be run for such a signal line also.

Whilst the present description of the invention concentrates on the visual display of the screen unit, it goes without saying that the present invention also encompasses suitable audio output units—preferably in the housing itself—which units emit to the outside (external to the housing) an audible audio signal (or an audio signal independent thereof) suited to accompanying the image display.

Especially for utilising the present invention in the context of wet rooms or similar spaces exposed to water or water-vapours, it has proven to be of advantage to construct the housing by means of suitable sealing means in such a way that operation of the mirror, screen display and lighting is possible without being impacted by environmental influences of this kind. Thus a preferred but not exclusive field of application of the present invention lies in the context of such environments, for example bathrooms, showers or other wet rooms.

In conclusion the present invention makes it possible, in a surprisingly simple manner, to produce an extremely flexible unit which can be easily fitted and retrofitted and which, tailored to users of the modern media age, allows these persons to consume audio-visual media in conjunction with a mirror function which is especially useful in the sanitary field.

Further advantages, features and details of the invention are revealed in the description of the preferred embodiments and in the drawings, in which

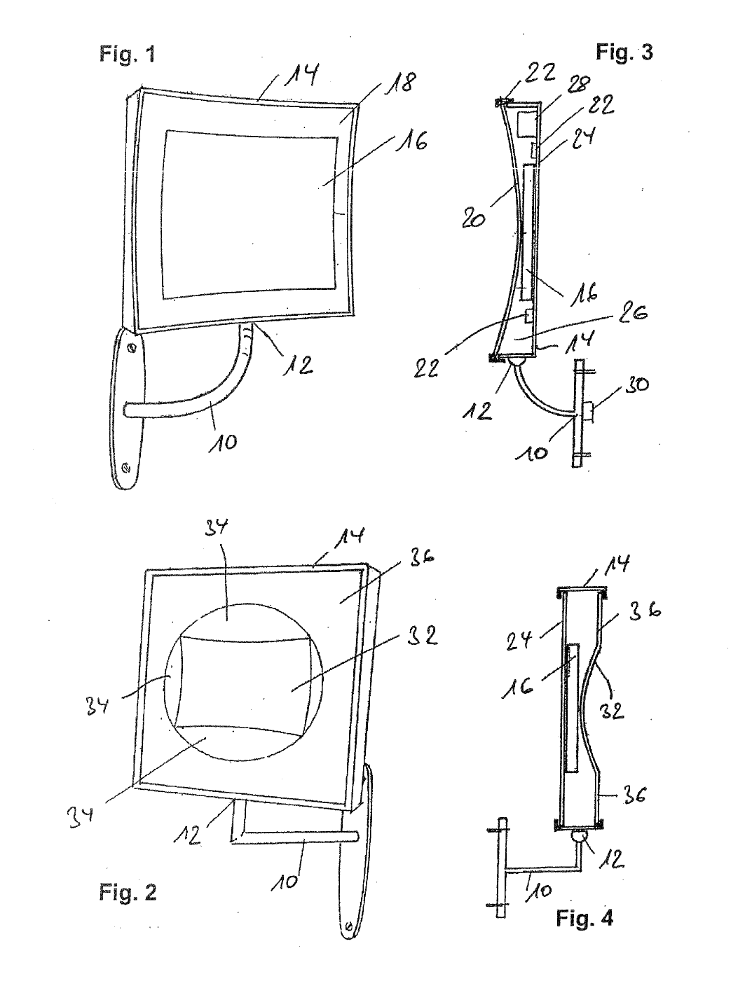

FIG. 1 shows a perspective view of the visual display unit according to a first preferred embodiment of the invention;

FIG. 2 shows an alternative implementation of the display unit according to a second embodiment;

FIG. 3 shows a longitudinal section through a third embodiment of the invention, and

FIG. 4 shows a longitudinal section analogous to FIG. 3 through a fourth embodiment of the invention.

With the embodiments to be explained in conjunction with FIGS. 1 to 4 functionally equivalent assemblies and functional units are marked by the same reference symbols.

The illustration in FIG. 1 represents a first embodiment. It can be seen how a bracket or swivel arm 10 attached to a wall supports a housing 14 at an end-side hinge 12 which in the illustration of FIG. 1 shows the first flat side, i.e. the side of a flat screen 16 filling the largest central area of the flat side. The screen 16 is surrounded by a front cover 18 in the form of a bezel which in the embodiment shown is fitted with a light source from behind so as to be translucent (not shown in the figure). The front cover/bezel 18 may consist of different materials, preferably glass but also mirror, metal, plastic etc. The screen 16 is a transparent surface or orifice.

FIG. 3 depicts the further structural layout of such an implementation using an equivalent but slightly different embodiment as regards details: at the back opposite the flat screen 16 a concave mirror insert 20 is fixed to the housing 14 with the aid of angle brackets (schematically shown); in the embodiment shown the mirror element 20 is shaped so as to cover the entire surface of the associated (second) flat side of housing 16 and provided with a mirror coating to form the concave mirror. However, the concave mirror has light-transparent orifices in the area of light sources 22 arranged inside the housing thus permitting the face of the user reflected in the mirror 20 to be illuminated. In the embodiment shown the front wall 24 also is shaped so as to be transparent allowing the light sources 22 to also shine through this flat side (first flat side) and insofar produce an illumination of the display 16 on the side of the rim. It is further to be seen that in the humidity-proof interior space 26 of the housing a schematically shown loudspeaker unit 28 is attached in such a way that this can reproduce an accompanying audio signal of the image played back on the visual display unit 16 (and alternatively of other stand-alone audio media). Using a suitable coupling with the housing the sound is transmitted to the outside to the viewer or listener in a humidity-proof manner. The sectional view of FIG. 3 indicates further, how by means of a single central connection 30 (this being favourable both for constructional and sealing reasons, such as in respect of its use in wet rooms) both the electric voltage supply for the screen unit 16 and light sources 22 can be supplied, and also the image or audio signal for display and reproduction by the units 16 and 28. In so far the modular unit shown in the embodiment of FIG. 3 (analogous to FIG. 1) is ideally suited for retrofits in various environments including wet environments such as bathrooms or the like, where, for example, the shown arrangements can be suitably mounted in the shape and form/size of shaving or makeup mirrors in conjunction with wash basins, bath tub rims or similar.

FIG. 2 indicates a further embodiment, and here the viewing angle is from the second flat side, i.e. the side of the concave mirror. One can recognise a central concave-mirror magnifying area 32 which is surrounded by four light segments 34 which are lit from behind (wherein the surface areas 34 are transparent in sections and, analogous to FIG. 3, suitably lit from behind by means of a light source). The flat side shown is completed by a surrounding cover 36 in the housing frame 14 which can be equipped with a plane mirror coating, for example.

The light areas 34 may also be implemented using alternative forms of illumination, such as luminous foils, LEDs, indirect lighting etc.

Finally the sectional view of FIG. 4, which in other respects can be arranged or organised in the same way as the above described embodiments, shows how a concave mirror area 32 of the kind shown in FIG. 2, which, as the longitudinal section shows, is concavely shaped in the centre and arched inwards, has a plane portion (for example provided with a mirror coating) in the rim area 36. In the rearward area again a (transparent) wall 24 is provided which (translucent for viewing) permits viewing of the audio-visual medium shown on the display 16 (here again an audio output unit not shown is provided, and provision may also be made for additional light sources partially shining through one or both flat sides).

FIG. 4 (and also FIG. 3) both reveal in a favourable way, how, in order to achieve as compact a housing as possible, the housing depth is practically determined by the inward arch of the concave mirror area 20 and 32 respectively as well as by the flat screen unit 16; in addition, depending on how much heat develops, air circulation gaps are to be provided within the framework of the invention.

As the figures reveal it is additionally possible in a simple way to swivel the housing unit 14 in such a way that either the viewer has an unobstructed line of view onto the screen 16, or he/she is facing the concave mirror area (20 and 32 respectively). The hinge 12 also, drawn in an exemplary fashion (and providing the sole link to the housing) makes it possible to adjust the housing unit as regards its rotational position, its tilt etc. This is easy mechanically and also reduces the sealing expense with regard to its environment in which it is used, and all feed lines—supply and signal lines for the system installed inside the housing—may be run through this one hinge. In order to make adjustability even more flexible, other hinge configurations are feasible, for example the swivel arm 10 can be provided with further hinges 12, in order to allow forward, backward and lateral tilting.

Adjustment of the swivel arm 10 can be effected by manual actuation and/or by remote-control actuation, for example by operating it by means of a remote control or touch sensor. For remote-control operation provision is made inside the housing 26 for a corresponding mechanical drive unit (not shown).

Provision is further made within the framework of the invention to provide access to the screen unit 16 (which in an otherwise known manner may be a TFT module which may be actuated by commonly used image or video standards such as TV/video, DVD formats, web formats including web video etc.) in such a manner that adjustments, such as adjustments to brightness, sound level, programme selection, activation of additional light sources and many more, for example, may be made by means of a touch functionality (touch screen) in the form of touch-sensitive surfaces on the screen not shown in any detail.

Further it is considered to lie within the scope of the invention that the shown unit can also be activated by a remote control (not shown), preferably wireless and in the common manner via infrared, Bluetooth, other radio protocols etc. thereby permitting operation in addition to or as an alternative to the touch screen. As a further development it would appear to even be possible to configure the shown unit as a playback unit for an internet access or the like, whereby then the control unit (for example inside the housing, or alternatively external to the housing) correspondingly associated with the screen 16 would have a corresponding computer or access and data preparation functionality.

Further it is feasible to activate the unit via (otherwise known) automatic in-house systems or bus systems which then also set further object-related parameters such as lighting activation or the like.

Further it lies within the framework of the invention to randomly combine all features shown merely by way of example in the figures and detailed in the more explicit description, so that, as a result, a universal easy-to-assemble and easy-to-be-retrofitted, distinctly operation-friendly unit is created in an extraordinarily flexible manner, which is also ideally suited for use in bathrooms or similar sanitary installations due being protected against humidity, water-vapours and spray water.

1. A restroom mirror with a housing having a mirror area offering a concave mirror optical effect at a second flat side opposite a first flat side, wherein fastening and adjusting means are disposed at the housing such that the housing can be fixed at a horizontal or vertical surface and can be rotated, swivelled and/or tilted through manual and/or mechanical action,
wherein
a flat screen is provided on a first flat side inside the housing, said screen being designed for the display of electronic image signals,
wherein the housing which is designed to be sealed for spray water and/or water vapour resistance and/or for compatibility with humid areas, can be moved from a first observation position of the flat screen to a second observation position of the mirror area through said actuation
and the fastening means comprise a hinge for facilitating the rotating, swivelling or tilting, said hinge as the central connection having cabling running therethrough for the electrical system provided in the housing.

2. The restroom mirror according to claim 1, wherein the hinge is a single hinge.

3. The restroom mirror according to claim 1, wherein the housing is a flat housing the housing depth of which between the first and second flat side is determined by an effective depth of the flat screen received in the housing and of the mirror area.

4. The restroom mirror according to claim 1, wherein the mirror area is implemented by a mirror insert provided at the second flat side, which mirror insert forms, on the whole or on part of its surface, an inwardly arched mirror area offering a concave mirror effect, in particular in the area of the surface centre.

5. The restroom mirror according to claim 4, wherein the mirror insert is shaped as a plane mirror area on the side of the rim, in particular in the area surrounding the surface centre.

6. The restroom mirror according to claim 4, wherein the housing is an arrangement designed to be sealed for spray water and/or water vapour resistance and/or for compatibility with humid areas, which arrangement consists of the mirror insert, a front wall forming the flat side as well as a housing frame encompassing the mirror insert as well as the front wall on the side of the rim.

7. The restroom mirror according to claim 1, wherein there is provided, in the second flat side, in particular surrounding the mirror area and/or adjacent to this, a light source and/or a translucent surface area backlit by a light source in the housing.

8. The restroom mirror according to claim 1, wherein a light source is provided in the housing, which light source, when activated, is visible at least through the first and/or second flat side.

9. The restroom mirror according to claim 7, wherein the light source is switchable by program control and/or can be adjusted for its brightness and/or colour effect via an operating element, in particular the flat screen,

10. The restroom mirror according to claim 1, wherein the mirror area is implemented by a mirror element which is semi-permeable at least over a part of its area.

11. The restroom mirror according to claim 1, wherein the flat screen, at least over a part of its surface, is a touch-sensitive screen accessible for manual actuation on the first flat side which screen is adapted for executing or setting up image display and/or programme parameters of the screen and/or parameters of a light source received in the housing and visible externally through the first and/or second flat side.

12. The restroom mirror according to claim 1, wherein the flat screen is associated with an electronic image signal reception unit which is connected to an external electronic image signal source via a wireless or wired link.

13. The restroom mirror according to claim 1, including a remote control unit cooperating with a control unit provided in the housing via a wireless link, said remote control unit being adapted for executing or setting up image display and/or programme parameters of the screen and/or parameters of a light source received in the housing and visible externally through the first and/or second flat side.

14. The restroom mirror according to claim 1, wherein the housing and/or the mirror area is dimensioned such that it forms an adjustable or shaving concave mirror.
